(19) United States
(12) Patent Application Publication
(10) Pub. No.: US 2009/0094474 A1
(43) Pub. Date: Apr. 9, 2009

(54) INFORMATION PROCESSING DEVICE

(75) Inventors: Keisuke Kaneko, Kyoto (JP); Masaitsu Nakajima, Osaka (JP); Takanobu Tani, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/994,041

(22) PCT Filed: Dec. 26, 2005
(86) PCT No.: PCT/JP2005/023719

§ 371 Date: Dec. 27, 2007

(30) Foreign Application Priority Data
Jun. 30, 2005 (JP) 2005-191400

(51) Int. Cl. G06F 12/02; G06F 1/04

(52) U.S. Cl. 713/500; 711/154; 711/E12.002

(57) ABSTRACT

An information processing device controls an access unit which accesses a memory corresponding to an address space where an address belongs, the address being generated using at least two pieces of address generation source information. The information processing device includes: a prediction unit which predicts one or more address spaces where the address to be accessed may potentially belong, using one piece of the address generation source information; an activation unit which activates accesses from the access unit to memories corresponding to all the address spaces predicted by the prediction unit; a determination unit which determines the address space where the address to be accessed belongs, the address being generated using the at least two pieces of the address generation source information; and an access stop unit which stops the accesses from the access unit, except for the access corresponding to the address space determined by the determination unit, out of the accesses activated under control of the activation unit.

### TECHNICAL FIELD

The present invention relates to an information processing device, such as a microprocessor, that accesses a memory.

### BACKGROUND ART

Many of appliances which handle video and audio are equipped with high performance processors. Such a processor is required to process multiple pieces of data within a short time or to process high-quality video and audio signals. As a means of realizing this requirement, there is a method whereby an operating frequency is improved.

In general, a method of increasing the number of pipeline stages is used as the means to achieve the improvement in the operating frequency. However, an increase in the number of pipeline stages in turn increases demerits, such as a larger penalty imposed when a branch instruction is executed.

The number of pipeline stages is determined depending on the number of stages needed to access a memory or on types of processes to be executed in these stages. What is important in the determination is a circuit delay which is caused between generation of an address of a memory to be accessed and activation of the access to the memory.

Generally speaking, an access to a memory includes from address generation to activation of access control for the memory. The address generation requires a circuit, such as an adder, which has many logic stages. The processing time of this circuit places limitations on improving the overall operating speed.

In the case of a memory access control circuit or a processor which controls an access to a memory for each corresponding space where an address belongs, the space where the address belongs needs to be decoded. Thus, time for determining the address and time for decoding the space where the address belongs are both required. For this reason, it is not easy to improve the clock cycle.

The following is an explanation as to a conventional method for accessing a memory, with reference to FIGS. 1 to 3. The method is described using a system which includes: a CPU with seven pipeline stages; a plurality of memories respectively corresponding to a plurality of address spaces; and a plurality of memory control units for respectively controlling accesses to the memories.

FIG. 1 shows a pipeline operation performed by the CPU. To be more specific, FIG. 1 illustrates that an Id instruction 110 which is a memory access instruction is present in each stage.

The pipeline includes an F1 stage 12, an F2 stage 13, a D1 stage 14, a D2 stage 15, an E1 stage 16, an E2 stage 17, and an E3 stage 18.

Instruction fetching is performed in the F1 stage 12 and the F2 stage 13, and instruction decoding is performed in the D1 stage 14 and the D2 stage 15. In the D2 stage 15, an access address is generated as well. The accesses to the memories are performed in the E1 stage 16 and the E2 stage 17.

When there is no factor for the pipeline to stop, the Id instruction 110, which is a memory access instruction, is present in each stage for each clock 11 as shown in FIG. 1. Then, a corresponding process is executed in each stage.

FIG. 2 shows a configuration of a conventional information processing device. For the purpose of simple explanation, FIG. 2 shows the configuration corresponding only to the D2 stage 15, the E1 stage 16, and the E2 stage 17 mentioned above.

A CPU 21 outputs an access address 212 and a memory access request 214 to a memory control unit 22.

The memory control unit 22 performs a different memory access control for each address space. FIG. 2 shows a configuration of the memory control unit 22 which accesses a Cache, an SRAM, and external memories provided via a BCU. The accesses to the SRAM and to the Cache are started in the E1 stage, and the access to the external memory provided via the BCU is started in the E2 stage.

The CPU 21 generates the access address 212 by adding an output value 208 from a register A207 and an output value 210 from a register B209 using an adder 211.

The access address 212 is inputted to a space determination unit 216 of the memory control unit 22. The space determination unit 216 determines an address space where the access address 212 belongs. Then, in accordance with the determination result, the space determination unit 216 outputs a Cache space determination signal 217, an SRAM space determination signal 218, or a BCU space determination signal 219 to an activation request generation unit 215.

The activation request generation unit 215 outputs an E1-memory control activation request 220 to an E1-main memory control unit 223 in accordance with the memory access request 214. At the same time, the activation request generation unit 215 outputs an E1-SRAM control activation request 221 to an E1-SRAM control unit 224 when the SRAM space determination signal 218 is inputted, and outputs an E1-Cache control activation request 222 to an E1-Cache control unit 225 when the Cache space determination signal 217 is inputted.

FIG. 3 shows timing for each process in the case of accessing the Cache space.

When the Id instruction 110 enters the D2 stage 15 in a cycle 31, the register-A output 208 and the register-B output 210 are outputted after a lapse of an output delay time tR302. Next, within a time tadd 303, the access address 212 is generated through the addition of the register-A output 208 and the register-B output 210. Then, the access address 212 is decoded during a time tdec 304, so that the access address space is determined.

To be more specific, in order to determine the address space in the cycle 31, a period of time (a delay time) obtained by calculating “tR 302+tadd 303+tdec 304” is needed. After a lapse of this time (the delay time), the various kinds of activation signals for the E1 stage 16 are generated.

In the case of a common CPU, a relatively long period of time is needed for a register file or an output from the adder to be finalized. For this reason, a time taken to generate an address is a main factor to determine an upper limit of a clock cycle, and is a bottleneck in speed enhancement.

In order to solve this problem, the following method is disclosed in Patent Reference 1. More specifically, an access to a memory is activated using part of the generated address, in parallel with which an address space is decoded. In a next cycle, when the address space corresponding to the activated access matches the decoded address space, the current access is continued.

### Patent Reference 1: Japanese Laid-Open Patent Application No. 2001-5663

### DISCLOSURE OF INVENTION

### Problems that Invention is to Solve

Using the above-mentioned conventional method, however, when the address space corresponding to the activated access is different from the decoded address space, the activated access is aborted so that the access to the correct space where the address belongs is executed afresh. This would cause a penalty to be incurred.

In view of the stated problem, an object of the present invention is to provide an information processing device which reduces the time taken to access memories without causing penalties, such as repetitive accesses to the memories.

### Means to Solve the Problems

In order to achieve the above object, an information processing device of the present invention is an information processing device for controlling an access unit which accesses a memory corresponding to an address space where an address belongs, the address being generated using at least two pieces of address generation source information, the information processing device including: a prediction unit which predicts one or more address spaces where the address to be accessed may potentially belong, using one piece of the address generation source information; an activation unit which activates accesses from the access unit to memories corresponding to all the address spaces predicted by the prediction unit; a determination unit which determines the address space where the address to be accessed belongs, the address being generated using the at least two pieces of the address generation source information; and an access stop unit which stops the accesses from the access unit, except for the access corresponding to the address space determined by the determination unit, out of the accesses activated under control of the activation unit.

As described, it is not that the information processing device of the present invention generates the access address and then makes the space determination, after which the device activates the control of the access to the memory. When generating the access address, the information processing device predicts, from a source value for generating the access address, spaces where the generated access address belongs. Then, the information processing device of the present invention activates the accesses to one or more memories corresponding to all the predicted spaces and, after this, determines the correct address space from the generated access address. Out of the plurality of activated accesses, the information processing device continues only the correct one and discontinues the ones which are off in the prediction. Accordingly, the information processing device of the present invention can reduce the time taken to access the memories without causing a penalty of repetitive accesses to the memories.

It should be noted that, when predicting a space, the information processing device of the present invention makes the space prediction so that the correct address space is definitely included in the predicted address spaces.

According to the information processing device of the present invention, for example, the address space where the address to be accessed belongs is determined depending on a value of a predetermined field of the address to be accessed, and the prediction unit predicts the address spaces where the address to be accessed may potentially belong, by determining an address space where the value of the predetermined field of the one piece of the address generation source information belongs as well as by judging a value which is one digit lower than the predetermined field of the one piece of the address generation source information.

Moreover, for example, the address to be accessed is generated by performing an addition or a subtraction on the at least two pieces of the address generation source information, and the prediction unit predicts the address spaces where the address to be accessed may potentially belong, by determining whether or not the lowest digit of the predetermined field of the one piece of the address generation source information varies, the determination being made by judging the value which is one digit lower than the predetermined field of the one piece of the address generation source information.

The information processing device of the present invention may further include a holding unit which holds space specifying information which specifies an address space where a value of a predetermined field of the one piece of the address generation source information belongs, wherein the address space where the address to be accessed belongs is determined depending on the value of the predetermined field of the address to be accessed, and the prediction unit predicts the address spaces where the address to be accessed may potentially belong, by using the space specifying information held by the holding unit as well as by judging a value which is one digit lower than the predetermined field of the one piece of the address generation source information.

For example, the address to be accessed is generated by performing an addition or a subtraction on the at least two pieces of the address generation source information, and the prediction unit predicts the address spaces where the address to be accessed may potentially belong, by determining whether or not the lowest digit of the predetermined field of the one piece of the address generation source information varies, the determination being made by judging the value which is one digit lower than the predetermined field of the one piece of the address generation source information.

The information processing device of the present invention may further include a supplying unit which supplies a clock to each of the memories corresponding to all the address spaces predicted by the prediction unit, and a clock stop unit which stops the clock supply from the supplying unit to the memories, except for the clock supply to the memory corresponding to the address space determined by the determination unit.

A memory access control method of the present invention is a method for controlling an access unit which accesses a memory corresponding to an address space where an address belongs, the address being generated using at least two pieces of address generation source information, the method including: a prediction step of predicting one or more address spaces where the address to be accessed may potentially belong, using one piece of the address generation source information; an activation step of activating accesses from the access unit to memories corresponding to all the address spaces predicted in the prediction step; a determination step of determining the address space where the address to be accessed belongs, the address being generated using the at least two pieces of the address generation source information; and an access stop step of stopping the accesses from the access unit, except for the access corresponding to the address space determined in the determination step, out of the accesses activated under control in the activation step.

### EFFECTS OF THE INVENTION

The present invention can provide an information processing device which can reduce the time taken to access memories without causing a penalty of repetitive accesses to the memories.

To be more specific, the present invention allows the overall clock cycle time of the information processing device to be reduced, thereby improving the operating frequency of the information processing device.

### BRIEF DESCRIPTION OF DRAWINGS

FIG. 1 is a diagram showing a pipeline operation of a CPU.

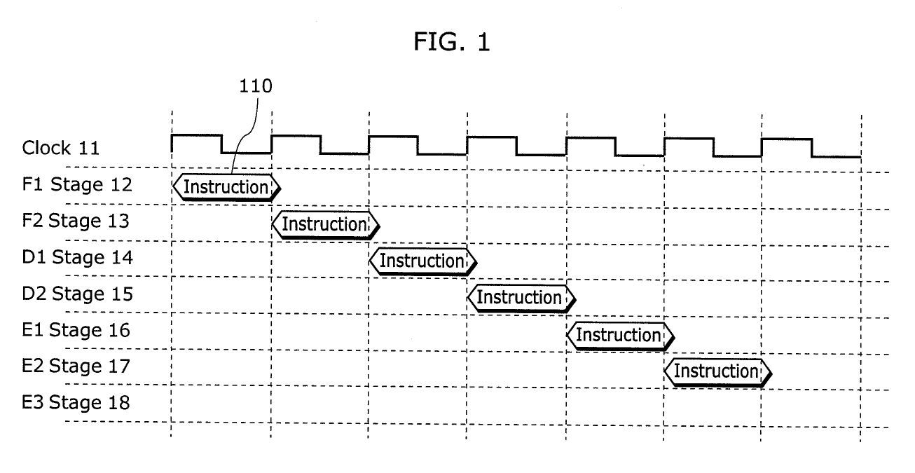

FIG. 2 is a diagram showing a configuration of a conventional information processing device.

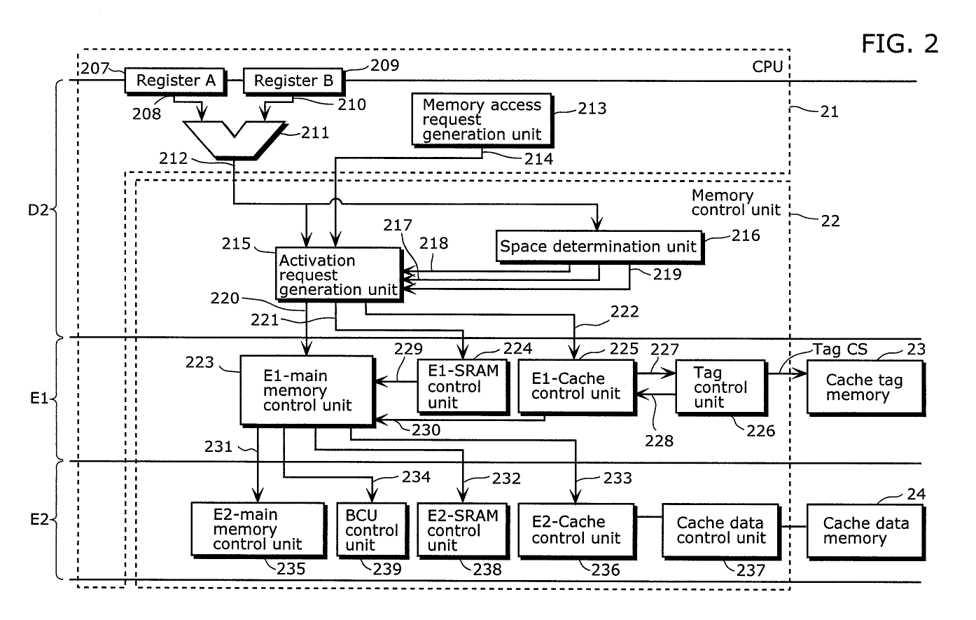

FIG. 3 is a diagram showing timing for each process in the case of accessing a Cache space.

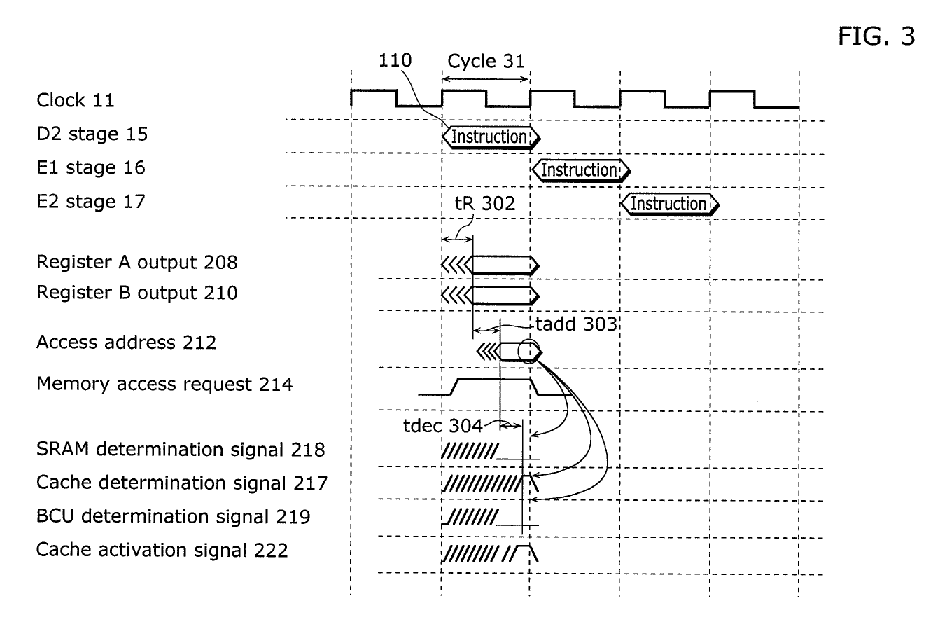

FIG. 4 is a diagram showing a configuration of an information processing device according to a first embodiment.

FIG. 5 is a diagram showing an address space.

FIG. 6 is a diagram showing a flow of a first space prediction.

FIG. 7 is a diagram showing a flow of a second space prediction.

FIG. 8 is a diagram showing a flow of a final space prediction.

FIG. 9 is a diagram showing timing for each process according to the first embodiment.

FIG. 10 is a diagram showing a configuration of an information processing device according to a second embodiment.

FIG. 11 is a diagram showing timing for each process in the case of accessing an SRAM according to the second embodiment.

FIG. 12 is a diagram showing timing for each process in the case of accessing a Cache according to the second embodiment.

FIG. 13 is a diagram showing a configuration of an information processing device according to a third embodiment.

FIG. 14 is a diagram showing timing for each process according to the third embodiment.

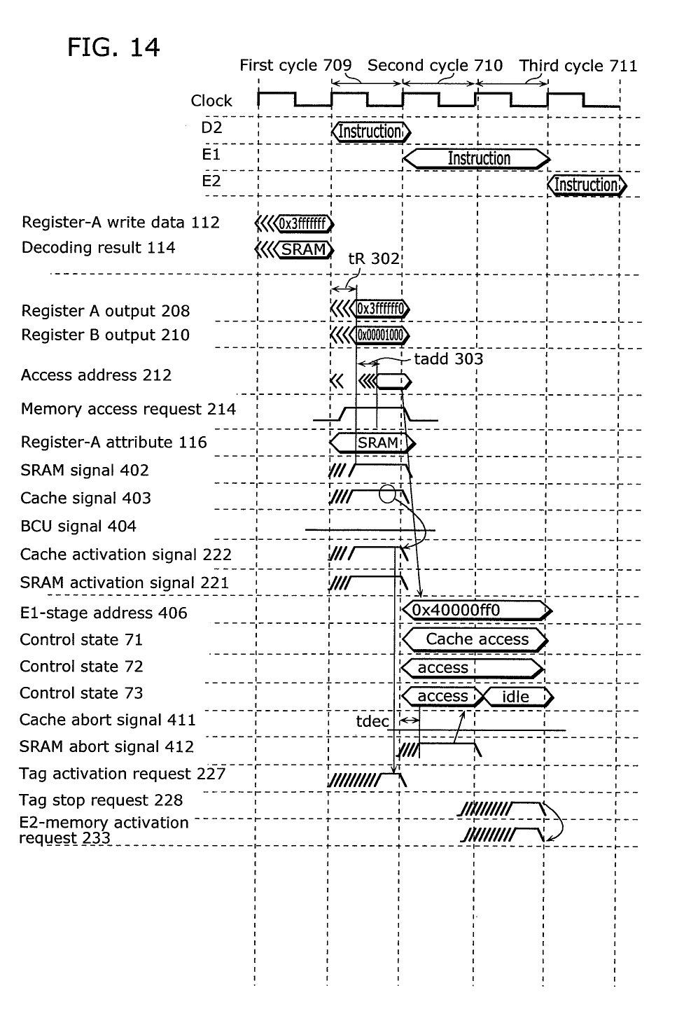

### NUMERICAL REFERENCES

11 clock
12 F1 stage
13 F2 stage
14 D1 stage
15 D2 stage
16 E1 stage
17 E2 stage
18 E3 stage
110 Id instruction
21 CPU
22 memory control unit
23 Cache tag memory
24 Cache data memory
207 register A
208 register-A output
209 register B
210 register-B output
211 adder
212 access address
213 memory access request generation unit
214 memory access request
215 activation request generation unit
216 space determination unit
217 Cache space determination signal
218 SRAM space determination signal
219 BCU space determination signal
220 E1-memory control activation request
221 E1-SRAM control activation request
222 E1-Cache control activation request
223 E1-main memory control unit
224 E1-SRAM control unit
225 E1-Cache control unit
226 tag control unit
227 tag activation request
228 tag stop signal
229 SRAM stop signal
230 Cache stop signal
231 E2-memory control activation request
232 E2-SRAM control activation request
233 E2-Cache control activation request
234 E2-BCU control activation request
235 E2-main memory control unit
236 E2-Cache control unit
237 Cache data control unit
238 E2-SRAM control unit
239 E2-BCU control unit
31 cycle
302 tR
303 tadd
304 tdec
401 space prediction unit
402 SRAM space prediction signal
403 Cache space prediction signal
404 BCU space prediction signal
405 E1-stage address holding unit
406 E1-stage address
407 E1-stage space determination unit
408 E1-stage SRAM space determination signal
409 E1-stage Cache space determination signal
410 E1-stage BCU space determination signal
411 Cache control abort signal
412 SRAM control abort signal
413 activation request generation unit
414 E1-main memory control unit
801 tag clock permission signal
802 tag clock
803 clock control unit
111 register-A write data generation unit
112 register-A write data
113 decoding unit
114 decoding result
115 register-A space attribute holding unit
116 register-A space attribute
71 E1-main memory control state
72 E1-Cache control state
73 E1-SRAM control state
74 E2-main memory control state
75 E2-Cache control state
76 Cache control state
77 BCU control state

### BEST MODES FOR CARRYING OUT THE INVENTION

The following is a description of the best modes for carrying out the present invention, with reference to the drawings.

### First Embodiment

First, an explanation is given as to an information processing device according to the first embodiment.

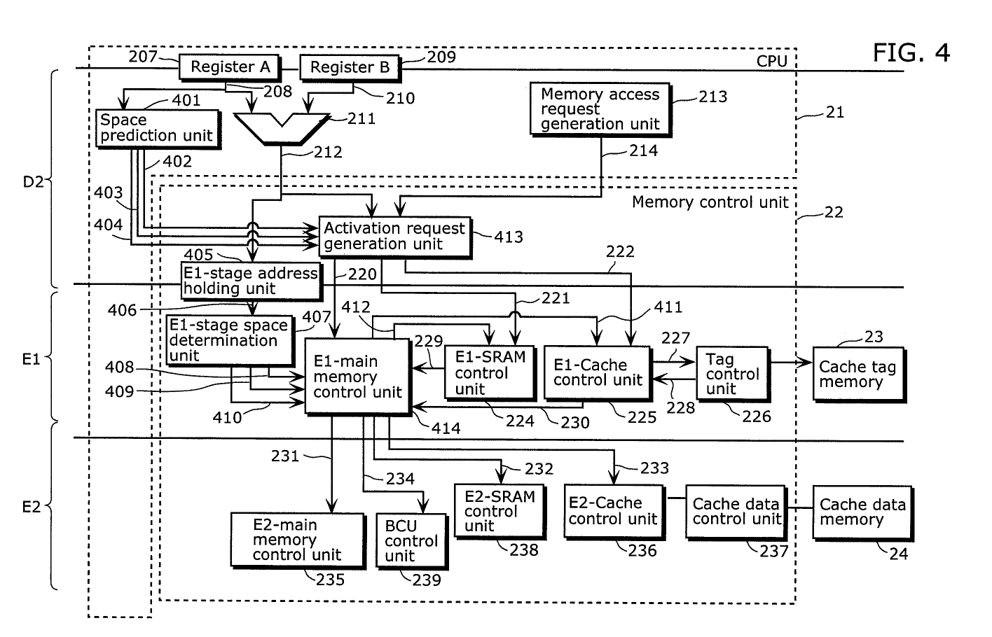

FIG. 4 shows a configuration of the information processing device according to the first embodiment.

In the first embodiment, suppose that a memory access instruction executed by a CPU 21 is an instruction for performing a memory access using an access address generated by adding a value from a register A 207 and a value from a register B 209. Also suppose that, when the address is generated through the above-mentioned addition, the address is generated by adding a 32-bit value of the register A 207 and a low order 16-bit value of the register B 209.

A register-A output 208 outputted from the register A 207 is inputted to a space prediction unit 401.

The space prediction unit 401 predicts an address space where an access address 212 belongs, on the basis of the value of the register-A output 208.

In accordance with the prediction result, the space prediction unit 401 outputs some of an SRAM space prediction signal 402, a Cache space prediction signal 403, and a BCU space prediction signal 404 to an activation request generation unit 413 of a memory control unit 22.

From a memory access request 214 and the some of the SRAM space prediction signal 402, the Cache space prediction signal 403, and the BCU space prediction signal 404, the activation request generation unit 413 generates and outputs some of an E1-memory control activation request 220, an E1-SRAM control activation request 221, and an E1-Cache control activation request 222. Depending on the prediction result, more than one activation request may be generated and outputted.

When the pipeline proceeds to an E1 stage, the access address 212 enters an E1-stage address holding unit 405 and is held during the execution of the memory access instruction in the E1 stage.

The memory control unit 22 causes an E1-stage space determination unit 407 to determine a correct address space where the access address 212 belongs using an E1-stage address 406. As a result of the determination, the E1-stage space determination unit 407 outputs an E1-stage SRAM space determination signal 408, an E1-stage Cache space determination signal 409, or an E1-stage BCU space determination signal 410 to an E1-main memory control unit 414.

On the basis of the space determination signal from the E1-stage space determination unit 407, the E1-main memory control unit 414 outputs an access abort signal to each control unit corresponding to the space other than the space where the E1-stage address 406 (the access address 212) belongs. For example, when the E1-stage address 406 belongs to the SRAM space, the E1-main memory control unit 414 outputs a Cache control abort signal 411 to an E1-Cache control unit 225. When the E1-stage address 406 belongs to the Cache space, the E1-main memory control unit 414 outputs an SRAM control abort signal 412 to an E1-SRAM control unit 224. When the E1 stage address 406 belongs to the BCU space, the E1-main memory control unit 414 activates the SRAM control abort signal 412 and the Cache control abort signal 411.

When the SRAM control abort signal 412 becomes active, the E1-SRAM control unit 224 aborts the SRAM access control in the E1 stage.

When the Cache control abort signal 411 becomes active, the E1-Cache control unit 225 aborts the Cache access control in the E1 stage.

To be more specific, when the memory access instruction is in the D2 stage, the space prediction unit 401 predicts a plurality of access spaces where the access address 212 may belong. Then, when the memory access instruction enters the E1 stage, the control units respectively corresponding to the plurality of the predicted access spaces where the access address 212 may belong are activated in the E1 stage.

When the memory access instruction is in the E1 stage, only the access to the memory from the control unit corresponding to the correct address space where the access address 212 belongs is executed whereas each access to the memory from the control unit which corresponds to the address space which is off in the prediction is aborted. Then, the memory access instruction enters the E2 stage.

In the D2 stage, the space prediction unit 401 predicts the plurality of access spaces where the access address may belong so that the correct access address where the access address 212 belongs is included. Thus, the control of accessing the correct address space in the E1 stage does not need to be restarted, on account of which a penalty of performing the same kind of process once again is not caused. Hereafter, the prediction made by the space prediction unit 401 is referred to as the “space prediction”.

The following is an explanation as to a method of the space prediction made by the space prediction unit 401 in the D2 stage.

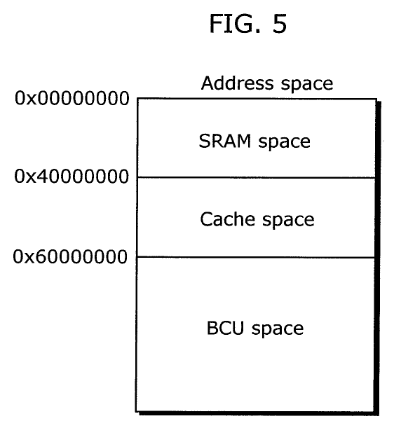

FIG. 5 shows an address space of the CPU.

Addresses from “0x00000000” to “0x3fffffff” are the addresses of the “SRAM space” to access the SRAM. Addresses from “0x40000000” to “05xfffffff” are the addresses of the “Cache space” to access the Cache. Addresses including and after “0x60000000” are the addresses of the “BCU space” to access an external device via the BCU.

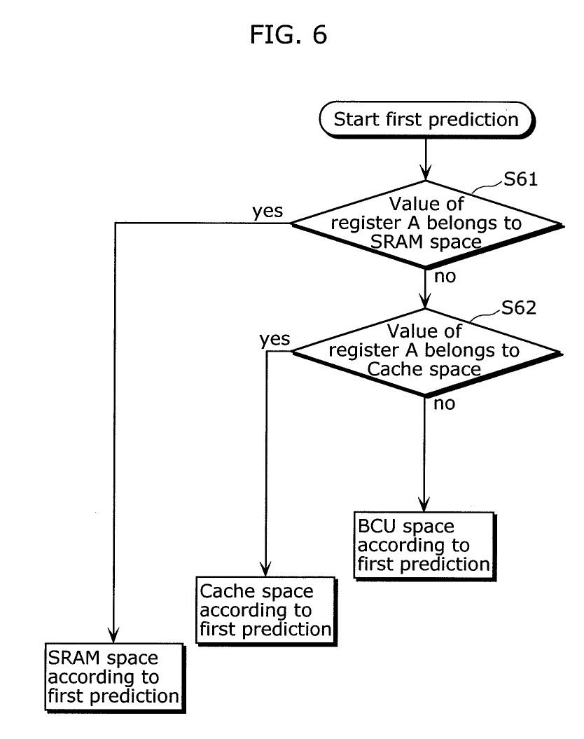

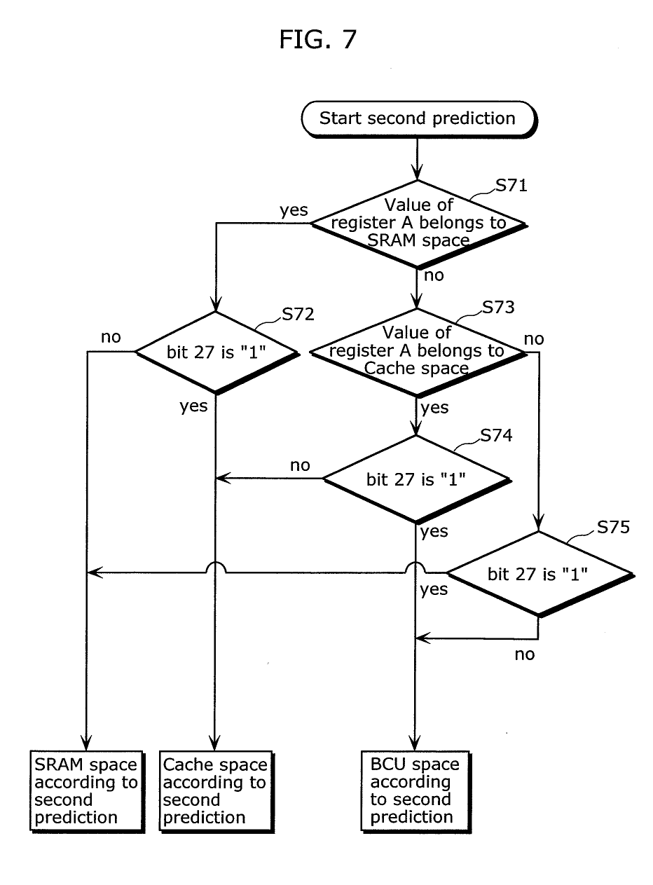

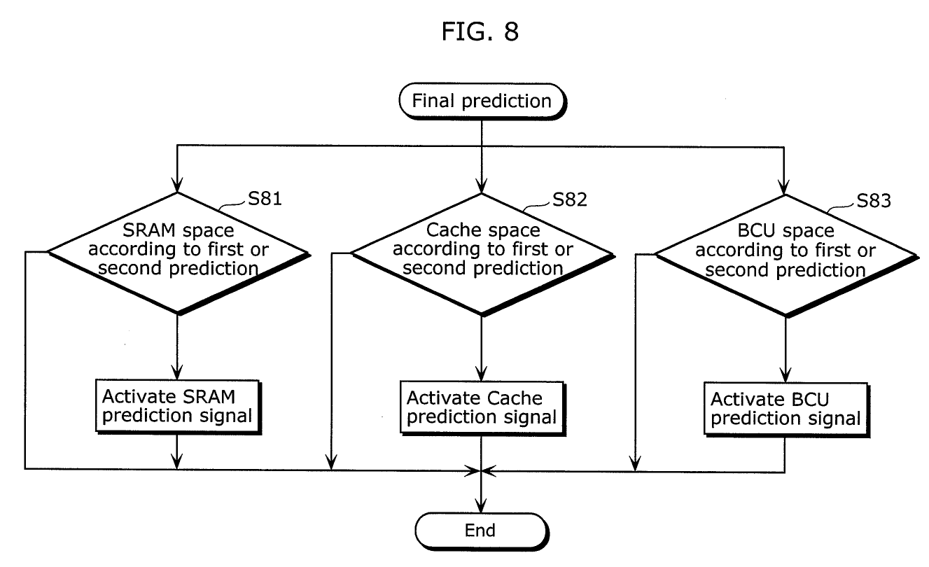

FIGS. 6 to 8 respectively show flows of the space prediction made by the space prediction unit 401. As shown in FIGS. 6 to 8, the space prediction unit 401 makes a first prediction (see FIG. 6) and a second prediction (see FIG. 7), and then makes a final prediction in accordance with the prediction results (see FIG. 8).

In the first prediction, the space prediction unit 401 determines an address space where the value of the register-A output that is an output value from the register A 207 belongs.

To be more specific, the space prediction unit 401 first judges whether or not the value of the register-A output 208 belongs to the SRAM space (S61 in FIG. 6). When judging that the value does not belong to the SRAM space (no in S61), the space prediction unit 401 judges whether or not the value of the register-A output 208 belongs to the Cache space (S62 in FIG. 6). When judging that the value does not belong to the Cache space (no in S62), the space prediction unit 401 judges that the value of the register-A output 208 belongs to the BCU space.

The space prediction unit 401 makes the second prediction in parallel with the first prediction.

In the second prediction, the space prediction unit 401 judges whether or not the value of the register A 207 is an address near any of the boundaries between contiguous address spaces shown in FIG. 5, and then predicts the address space where the access address 212 obtained by the adder 211 belongs.

As explained above, the CPU 21 generates the access address 212 by adding the value of the register A 207 and the value of the register B 209. Here, only the low order 16 bits are used, out of the value of the register B 209. Suppose that a field used for determining the address space is from bit 28 to bit 31. In this case, the space where the value of the register A 207 belongs is different from the space where the access address 212 belongs, when a value of the field from bit 28 to bit 31 varies because of the addition, that is to say, when bit 27 of the value of the register A 207 is “1”. In the second prediction, the space prediction unit 401 judges whether or not bit 27 of the value of the register A 207 is “1”.

To be more specific, the space prediction unit 401 first judges whether or not the value of the register A 207 belongs to the SRAM space (S71 in FIG. 7). When the value of the register A 207 belongs to the SRAM space (yes in S71), the space prediction unit 401 judges whether or not the value of bit 27 in the value from the register A 207 is “1” (S72). When the value of bit 27 is “1” (yes in S72), the space prediction unit 401 predicts in the second prediction that the space where the access address 212 belongs is the Cache space. When the value of bit 27 is “0” (no in S72), the space prediction unit 401 predicts in the second prediction that the space where the access address 212 belongs is the SRAM space.

When not judging that the value of the register A 207 belongs to the SRAM space in S71 (no in S71), the space prediction unit 401 judges whether or not the value of the register A 207 belongs to the Cache space (S73). When the value of the register A 207 belongs to the Cache space (yes in S73), the space prediction unit 401 judges whether or not bit 27 of the value from the register A 207 is “1” (S74). When bit 27 is “1” (yes in S74), the space prediction unit 401 predicts in the second prediction that the space where the access address 212 belongs is the BCU space. When bit 27 is “0” (no in S74), the space prediction unit 401 predicts in the second prediction that the space where the access address 212 belongs is the Cache space.

Moreover, when not judging that the value of the register A 207 belongs to the Cache space in S73 (no in S73), the space prediction unit 401 judges whether or not bit 27 of the value from the register A 207 is “1” (S75). When bit 27 is “1” (yes in S75), the space prediction unit 401 predicts in the second prediction that the space where the access address 212 belongs is the SRAM space. When bit 27 is “0” (no in S75), the space prediction unit 401 predicts in the second prediction that the space where the access address 212 belongs is the BCU space.

After the ends of the first and second predictions, the space prediction unit 401 makes the final prediction. In accordance with this prediction result, the space prediction unit 401 activates the control abort signal corresponding to the space.

In the final prediction, when obtaining the SRAM space as the prediction result on the basis of the first prediction or the second prediction (S81 in FIG. 8), the space prediction unit 401 activates the SRAM space prediction signal 402. When obtaining the Cache space as the prediction result on the basis of the first prediction or the second prediction (S82), the space prediction unit 401 activates the Cache space prediction signal 403. When obtaining the BCU space as the prediction result on the basis of the first prediction or the second prediction (S82), the space prediction unit 401 activates the BCU space prediction signal 404.

In accordance with the above flow, when the value of the register A 207 is “0x30000000, for example, the space prediction unit 401 outputs only the SRAM space prediction signal 402. When the value of the register A 207 is “0x3ffffff0”, the space prediction unit 401 outputs the SRAM space prediction signal 402 and the Cache space prediction signal 403.

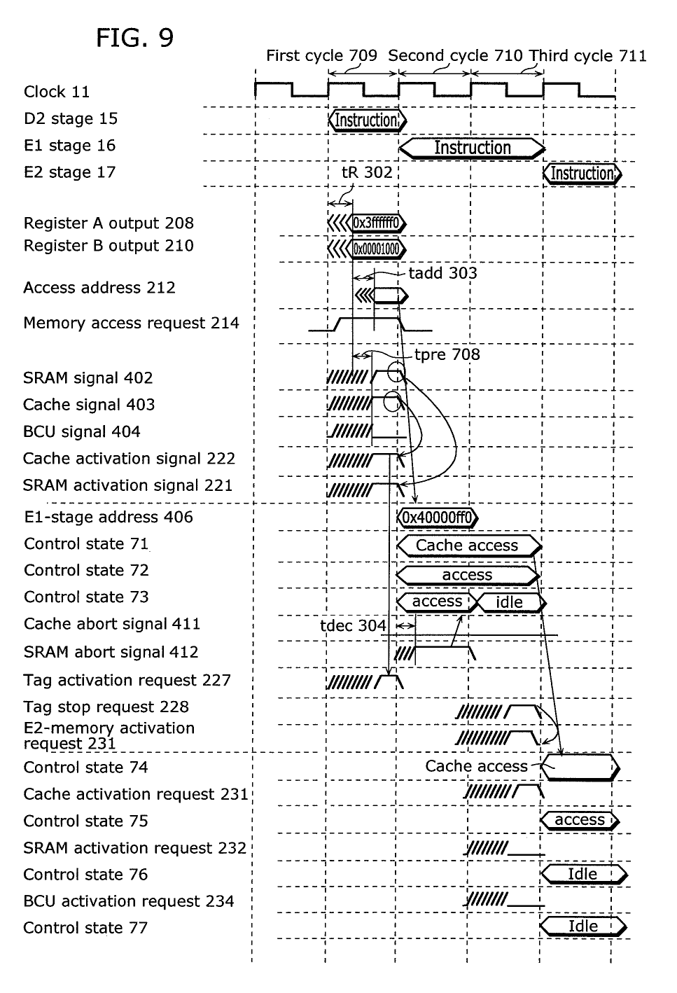

FIG. 9 shows timing for each process when the value of the register A 207 is “0x3ffffff0” and the value of the register B 209 is “0x1000”. In the case shown in FIG. 9, the access address 212 is “0x40000ff0”, so that the space which is to be accessed is the Cache space.

FIG. 9 shows the case where it takes 2 cycles for some reason to access the Cache in the E1 stage.

The space prediction unit 401 makes the first prediction using the value of the register A 207. In the case shown in FIG. 9, the space prediction unit 401 obtains the SRAM space as the result of the first prediction.

Moreover, since the value of the register A 207 belongs to the SRAM space and bit 27 is “1”, the space prediction unit 401 obtains the Cache space as the result of the second prediction.

The space prediction unit 401 obtains the SRAM space and the Cache space as the result of the final prediction on the basis of the first prediction and the second prediction. Accordingly, the space prediction unit 401 outputs the SRAM space prediction signal 402 and the Cache space prediction signal 403.

An output delay of these signals is the sum of: a tR 302 which is a period of time required to read the value of the register A 207; and a tpre 708 which is a period of time required to decode the high order 4 bits and bit 27 of the value of the register A 207. The tpre 708 is shorter than a tadd 303 which is an output delay of the 32-bit adder. Note that a tdec 304 for decoding the addition result is not included in the output delay. For this reason, the delay in outputting the SRAM space prediction signal 402 and the Cache space prediction signal 403 is shorter than the delay in decoding and outputting the addition result. On account of this, the E1 stage can be started earlier than the case where the address is decoded and the address space is determined in the D2 stage.

When the Id instruction 110 enters the E1 stage, the space of the E1-stage address 406 is determined. In the case shown in FIG. 9, the E1-stage address 406 belongs to the Cache space because the E1-stage address 406 is “0x40000ff0”. Thus, the SRAM control abort signal 412 corresponding to the E1-SRAM control unit 224 is activated. The timing of outputting the SRAM control abort signal 412 is immediately after the tdec 304 which is required to decode the address.

Receiving the SRAM control abort signal 412, the E1-SRAM control unit 224 aborts the SRAM control.

On the other hand, the E1-Cache control unit 225 continues the control, and the E1-main memory control unit 414 activates an E2-SRAM control activation request 232 in a cycle 711 in which a tag stop signal 228 is received from a tag control unit 226. At the same time, the Id instruction 110 proceeds to the process in the E2 stage.

As described above, the information processing device according to the first embodiment can reduce the processing delay in the D2 stage and thus reduce the clock cycle. To be more specific, the device allows the operating frequency to be improved.

Also, in making the space prediction, the space prediction unit 401 can predict the spaces so that the correct space where the access address 212 belongs is included. This is to say, one of the plurality of controls activated in E1 stage is correct. Out of the predicted controls, only the correct control is continued and the controls which are off in the prediction are aborted. This can eliminate the necessity of restarting the controls activated in the E1 stage.

Accordingly, the information processing device according to the first embodiment can improve the clock cycle without increasing penalties.

When the memory access request generation unit 213 outputs the memory access request 214, all of the E1-SRAM control unit 224, the E1-Cache control unit 225, and the E2-BCU control unit 239 respectively activate the controls of accessing the corresponding memories so that the clock cycle can be improved without an penalty. In this case, however, a large amount of electric power is needed. On the other hand, in the case of the information processing device according to the first embodiment, not all of the control units perform the memory access control, thereby reducing the power consumption.

Also, the explanation has been given in the first embodiment with the assumption that the field used for determining the address space is from bit 28 to bit 31. However, the field for determining the address space is not limited to the field from bit 28 to bit 31. Thus, the space prediction unit 401 judges in the second prediction whether a value of a bit, which is one bit lower than the field for determining the address space in the value of the register A 207, is “1” or “0”.

Moreover, the explanation has been given in the first embodiment with the assumption that the access address 212 is generated by adding the value of the register A 207 and the value of the register B 209. However, the access address 212 may be generated by subtracting the value of the register B 209 from the value of the register A 207. In this case, the spaces determined in the second prediction depending on “1” or “0” of the value of the bit, which is one bit lower than the field for determining the address space in the value of the register A 207, are reversed to the case of the first embodiment described above.

Furthermore, the space prediction unit 401 in the first embodiment is an example of a prediction unit of the information processing device of the present invention. The activation request generation unit 413 is an example of an activation unit of the information processing device of the present invention. The E1-stage space determination unit 407 is an example of a determination unit of the information processing device of the present invention. The E1-main memory control unit 414 is an example of an access stop unit of the information processing device of the present invention.

### Second Embodiment

Next, an explanation is given as to an information processing device according to the second embodiment.

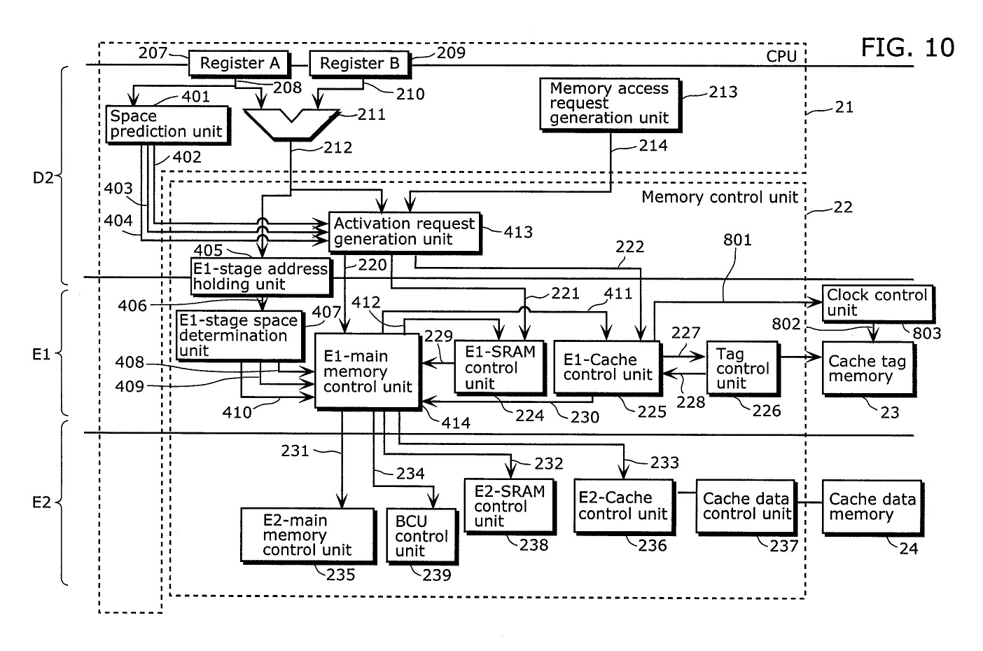

FIG. 10 shows a configuration of the information processing device according to the second embodiment.

The information processing device according to the second embodiment is a device whereby supply of clocks to a Cache tag memory 23 can be controlled and a clock control unit 803 stops the supply of clocks to the Cache tag memory 23 using a tag clock permission signal 801.

As is the case with the first embodiment, the space prediction unit 401 makes the space prediction so that the accesses to the memories are controlled and that the supply of clocks to the Cache tag memory 23 is controlled as well.

Only when controlling the access to the Cache, the E1-Cache control unit 225 supplies the tag clock permission signal 801 to the clock control unit 803. That is to say, only when the E1-Cache control unit 225 is “currently in access”, the tag clock permission signal 801 becomes active.

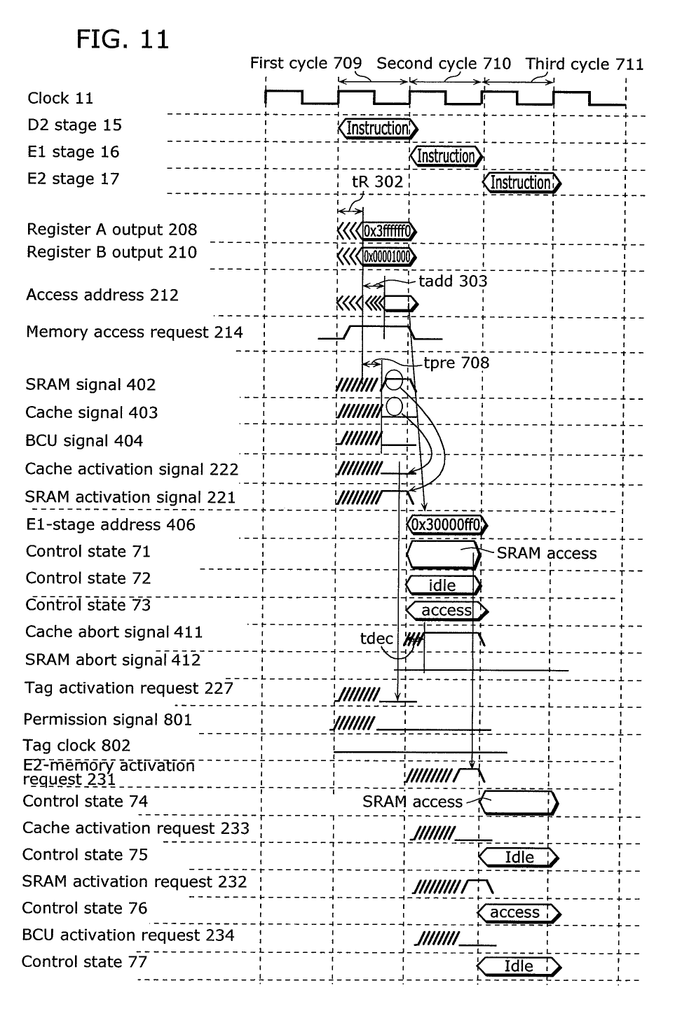

FIG. 11 is a diagram showing execution timing for each process in the case of accessing the SRAM space. FIG. 11 shows the execution timing for each process in the case where the value of the register A 207 is “0x30000000” and the value of the register B 209 is “0x00001000”.

The control of the accesses to the memories in accordance with the space prediction and its prediction result is performed as is the case with the first embodiment. In the case shown in FIG. 11, only the SRAM space is obtained as the final predicted space and, therefore, only the SRAM space prediction signal 402 becomes active. In this case, since the E1-Cache control unit 225 is not activated, the tag clock permission signal 801 does not become active and thus a tag clock 802 is not supplied to the Cache tag memory 23.

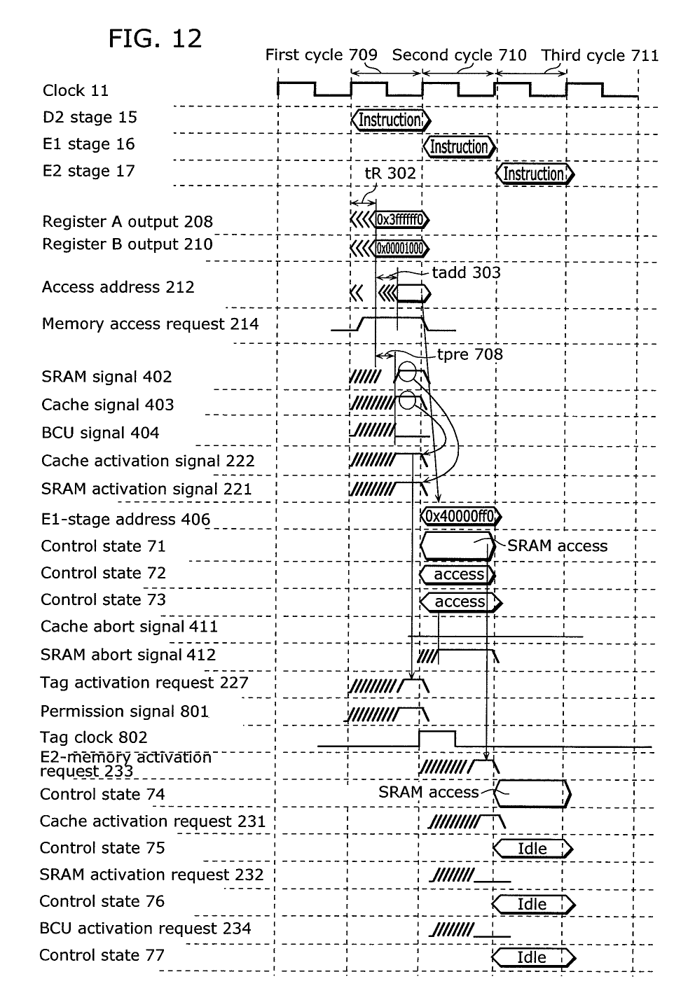

FIG. 12 shows execution timing for each process in the case of accessing the Cache space. FIG. 12 shows the execution timing for each process in the case where the value of the register A 207 is “0x3fffffff0” and the value of the register B 209 is “0x00001000”.

The control of the accesses to the memories in accordance with the space prediction and its prediction result is performed as is the case with the first embodiment. In the case shown in FIG. 12, the SRAM space and the Cache space are obtained as the final predicted spaces and, therefore, the SRAM space prediction signal 402 and the Cache space prediction signal 403 become active. In the E1 stage, however, the SRAM control abort signal 412 is outputted, so that the E1-SRAM control unit 224 is aborted. The E1-Cache control unit 225 continues the process because the prediction result is correct. Moreover, in accordance with the Cache space prediction signal 403, the E1-Cache control activation request 222 and the tag activation request 227 are outputted. Accordingly, the E1-Cache control unit 225 supplies the tag clock permission signal 801 to the clock control unit 803, and the clock control unit 803 supplies the tag clock 802 to the Cache tag memory 23.

On the other hand, when the SRAM space and the Cache space are obtained as the final predicted spaces and the correct address space where the access address 212 belongs is the SRAM space, the following operation is performed. More specifically, in accordance with the space prediction which is finally obtained, the SRAM space prediction signal 402 and the Cache space prediction signal 403 become active, and the E1-SRAM control unit 224 causes a clock control unit, which is intended for the SRAM and is not shown in the drawing, to supply an SRAM clock, which is not shown in the drawing, to the SRAM. Also, the E1-Cache control unit 225 supplies the tag clock permission signal 801 to the clock control unit 803, and the clock control unit 803 supplies the tag clock 802 to the Cache tag memory 23. Then, because the correct address space is the SRAM space, the E1-Cache control unit 225 supplies a tag clock stop signal to the clock control unit 803 in order for the clock control unit 803 to stop supplying the tag clock 802 to the Cache tag memory 23.

In general, a unit (a block) for controlling the supply of clocks is likely to be located at a higher level of a clock tree whereas a unit (a block) for generating a clock supply signal is likely to be located at a lower level of the clock tree. For this reason, it is desirable that the clock supply signal should be outputted at an early time in one cycle.

In the case of using the space determination result obtained on the basis of the access address 212 by the E1-stage space determination unit 407, the timing to generate the tag clock permission signal 801 is delayed due to the access to the Cache. For this reason, the overall clock cycle cannot be improved.

The information processing device according to the second embodiment allows the clock cycle for generating the tag clock permission signal 801 to be improved using the space prediction result obtained by the space prediction unit 401.

### Third Embodiment

Next, an explanation is given as to an information processing device according to the third embodiment.

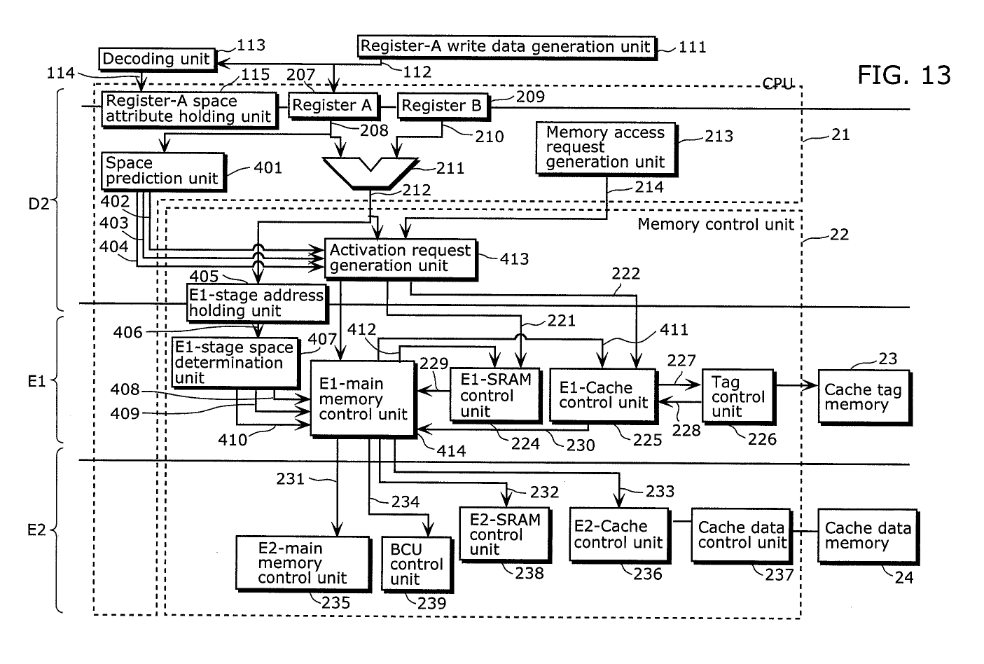

FIG. 13 shows a configuration of the information processing device according to the third embodiment.

The information processing device according to the third embodiment makes the space prediction at high speed.

When writing a value to the register A 207, the information processing device shown in FIG. 13 holds, in a separate holding unit, a determination result showing the space where the value of the register A 207 belongs, for a case where the value is used for generating an access address to access a memory. Then, the determination result is used for the space prediction made in the D2 stage.

A register-A write data generation unit 111 generates register-A write data 112 which is data to be written to the register A 207. The register-A write data 112 is inputted not only to the register A 207, but to a decoding unit 113 which determines an address space where the data belongs for a case where the data itself is used as an address.

A space determination result (a decoding result) 114 obtained by the decoding unit 113 is held in a register-A space attribute holding unit 115 at the same time when the register-A write data 112 is written to the register A 207. To be more specific, the data input to the register-A space attribute holding unit 115 is synchronized with the data input to the register A 207.

A register-A space attribute 116 which is obtained as the space determination result by the decoding unit 113 is inputted to the space prediction unit 401. The space prediction unit 401 then makes the prediction as is the case with the first embodiment. Here, in the first embodiment, the space prediction unit 401 determines the space where the value of the register A 207 belongs on the basis of the register A output 208. In the third embodiment, the space prediction unit 401 references only to bit 27 of the value from the register A 207, using the register-A space attribute 116 which is the information from the register-A space attribute holding unit 115.

Accordingly, the process to determine the space from a plurality of bits of the register A 207 is eliminated, and therefore the space prediction unit 401 can obtain the space prediction result faster than the case of the first embodiment. More specifically, it becomes possible to improve the overall clock cycle of the information processing device.

### INDUSTRIAL APPLICABILITY

The present invention is useful for an information processing device which operates in accordance with the clock synchronization and, in particular, for a microprocessor, a digital signal processing circuit, and a system LSI which have memory systems employing a different type of access method for each address space.

1. An information processing device for controlling an access unit which accesses a memory corresponding to an address space where an address belongs, the address being generated using at least two pieces of address generation source information, said information processing device comprising:
a prediction unit operable to predict one or more address spaces where the address to be accessed may potentially belong, using one piece of the address generation source information;
an activation unit operable to activate accesses from said access unit to memories corresponding to all the address spaces predicted by said prediction unit;
a determination unit operable to determine the address space where the address to be accessed belongs, the address being generated using the at least two pieces of the address generation source information; and
an access stop unit operable to stop the accesses from said access unit, except for the access corresponding to the address space determined by said determination unit, out of the accesses activated under control of said activation unit.

2. The information processing device according to claim 1,
wherein the address space where the address to be accessed belongs is determined depending on a value of a predetermined field of the address to be accessed, and
said prediction unit is operable to predict the address spaces where the address to be accessed may potentially belong, by determining an address space where the value of the predetermined field of the one piece of the address generation source information belongs as well as by judging a value which is one digit lower than the predetermined field of the one piece of the address generation source information.

3. The information processing device according to claim 2,
wherein the address to be accessed is generated by performing an addition or a subtraction on the at least two pieces of the address generation source information, and
said prediction unit is operable to predict the address spaces where the address to be accessed may potentially belong, by determining whether or not the lowest digit of the predetermined field of the one piece of the address generation source information varies, the determination being made by judging the value which is one digit lower than the predetermined field of the one piece of the address generation source information.

4. The information processing device according to claim 1, further comprising
a holding unit operable to hold space specifying information which specifies an address space where a value of a predetermined field of the one piece of the address generation source information belongs,
wherein the address space where the address to be accessed belongs is determined depending on the value of the predetermined field of the address to be accessed, and
said prediction unit is operable to predict the address spaces where the address to be accessed may potentially belong, by using the space specifying information held by said holding unit as well as by judging a value which is one digit lower than the predetermined field of the one piece of the address generation source information.

5. The information processing device according to claim 4,
wherein the address to be accessed is generated by performing an addition or a subtraction on the at least two pieces of the address generation source information, and
said prediction unit is operable to predict the address spaces where the address to be accessed may potentially belong, by determining whether or not the lowest digit of the predetermined field of the one piece of the address generation source information varies, the determination being made by judging the value which is one digit lower than the predetermined field of the one piece of the address generation source information.

6. The information processing device according to claim 1, further comprising:
a supplying unit operable to supply a clock to each of the memories corresponding to all the address spaces predicted by said prediction unit, and
a clock stop unit operable to stop the clock supply from said supplying unit to the memories, except for the clock supply to the memory corresponding to the address space determined by said determination unit.

7. A method for controlling an access unit which accesses a memory corresponding to an address space where an address belongs, the address being generated using at least two pieces of address generation source information, said method comprising:
a prediction step of predicting one or more address spaces where the address to be accessed may potentially belong, using one piece of the address generation source information;
an activation step of activating accesses from the access unit to memories corresponding to all the address spaces predicted in said prediction step;
a determination step of determining the address space where the address to be accessed belongs, the address being generated using the at least two pieces of the address generation source information; and
an access stop step of stopping the accesses from the access unit, except for the access corresponding to the address space determined in said determination step, out of the accesses activated under control in said activation step.
